(19) United States
(12) Patent Application Publication
(10) Pub. No.: US 2007/0070395 A1
(43) Pub. Date: Mar. 29, 2007

(54) Handheld printer alert system

(75) Inventors: Adam Jude Ahne, Lexington, KY (US); Edmund Hulin James III, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/235,331

(22) Filed: Sep. 26, 2005

(51) Int. Cl. G06F 3/12

(52) U.S. Cl. 358/1.15; 358/1.16

(57) ABSTRACT

A portable printing device is described that monitors a print progress as an image is printed and generates an alert when an image has finished printing. Methods of detecting an end-of-image condition are described as are a variety of alert systems that notify the user that he or she has completed printing of an image.

### FIELD OF THE INVENTION

The present invention relates generally to handheld printers, and more particularly, to systems, methods and apparatuses for identifying the completion of a printed image.

### BACKGROUND OF THE INVENTION

A function of a handheld printer is the repetitive printing of a particular image to create a pattern. For example, it may be desired for one to print consecutively a company logo as an identifying marker on product packaging. In such an instance, a user may employ a handheld printer to apply the image or images directly to the packaging. Unlike a conventional printer in which flat media, such as paper, is fed into a stationary printer, a handheld printer allows the printing of text or images onto media of different shapes and sizes.

Handheld printing is a relatively new phenomenon and those handheld printers that are known in the art provide no feedback to the user to alert them when an image has finished printing. As a result, the user may either stop printing at a point where the image is only partially completed, or the user may wait too long to discontinue printing and end up with the start of a partially finished unwanted image at the end of a printed line.

The printing process in a handheld printer is typically started and stopped by pressing a “print” button. The printer is applied against a desired printing surface where the user wants an image to be printed. The printer is aligned with the printing surface in a fashion so that the image may be linearly printed across the surface. When the user presses the print button, the printer begins printing a desired sequence of images onto the printing surface. In the case of a print operation in which a single image is printed repeatedly across a print surface, when one image is printed, the printer immediately, or after a brief pause, begins printing the next image upon completion of the previous image. This process continues for as long as the user depresses the print button.

One problem, however, is that the printing device often obstructs the user's view of what has been printed. This makes it hard for the user to determine when one image has been completed and when the next image has started to print.

A need therefore exists in the art for an improved handheld printer and handheld printing process that addresses this and other problems that are known in the art.

### BRIEF SUMMARY OF THE INVENTION

According to an embodiment of the present invention, a handheld printer detects a completed printing image via a memory file containing the image and a pointer at the end of the file. In some embodiments, the pointer represents an end of an image to be printed. The handheld printer uses the pointer to detect that it has reached the end of the current image and conveys that information to the user to allow the user to decide whether to stop printing or continue printing the next image. In one described embodiment, a visual alert is conveyed through a flashing LED light.

According to an embodiment of the present invention, there is disclosed a method of alerting the user that the end of a printed image has been reached through an LCD display integrated with a handheld printer. The method includes communication between the detection means and a processor within the handheld printer. The processor translates the information and displays the appropriate message on the LCD display.

According to an optional aspect of the above embodiment, the LCD display may display the image currently printing through a real-time algorithm that displays the status of the image as it is printed. As described herein, the LCD display includes a representation that shows that portion of the image that has been printed. For example, if 40 percent of the image has been printed, 40 percent of the image can be displayed. Alternatively, the LCD can display a bar code, pie chart or other indicia that represents to the user that percentage or that portion of an image that has been printed. While much of the description herein describes a handheld printer that is printing multiple repetitions of a single image in a linear fashion, one of ordinary skill will readily understand that the processes described have equal applicability for the printing of a single image or the printing of a sequence of different images.

A printing surface is defined to be the print receiving media or object including paper sheets, cartons, printable object or media, or any other surface capable of receiving an ink, dye, or other material to be applied to the surface. According to an aspect of the present invention, a method comprises the steps of moving a handheld printer over the printing surface; determining the progress of a printhead relative to the completeness of the current image being printed; and continuing to print the corresponding portion of the image onto a corresponding portion of the printing surface. A manual movement of the handheld printer head is performed through a series of continuous or near-continuous motions.

Any image(s) to be printed on the printing surface may be stored in a memory of the handheld printer in a bit-mapped representation, printable format, or other acceptable format. An image may also be optically scanned and stored electronically in the printer memory as a digital representation of the image. The handheld printer may have an integrated memory component which stores the image data representing the image to be printed. Printing may be initiated via a user input means (e.g., a button). A controller may be connected to the handheld printer to trigger the printer to reset after an image or series of images are printed to allow successive reproductions of an image or series.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a view of a handheld printer having an LED indicator, according to an embodiment of the present invention.

FIG. 2 is a view of a handheld printer having an LCD screen, which has printed a potion of a number of repetitive images onto a printing surface.

FIG. 3 is a block diagram flow chart of an end of image detection and alert method, according to an illustrative embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

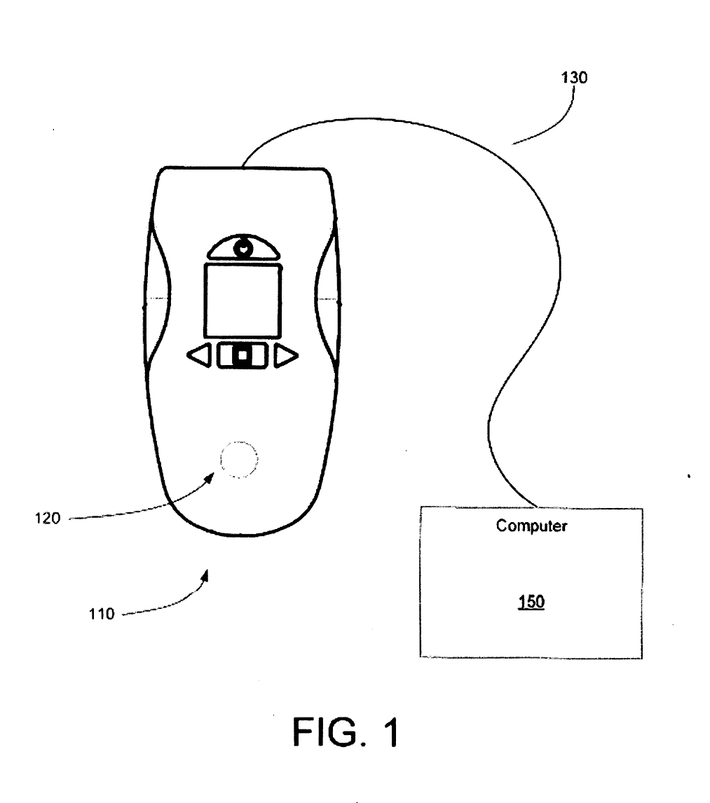

FIG. 1 is a view of a handheld printer 110 having an LED indicator 120, according to an embodiment of the present invention. The handheld printer ink cartridge 110 shown in FIG. 1 contains therein a printhead (not shown), which emits the marking substance (i.e., ink) onto a printing surface.

The handheld printer 110 may receive image data from a number of sources. In one instance the handheld printer 110 is connected by cable 130 or wireless interface to computer 150. The image data resides initially in a file stored in memory on the computer 150 and is transferred to the memory on handheld printer 110. Once the image file is stored in the memory of the handheld printer 110, the user may commence printing the image. In alternate embodiments of the present invention, a memory card or other electronic storage media contains one or more image files and is insertable into the handheld printer 110 to transfer the image to the printer memory or to serve as printer memory.

The user may initiate printing through the issuance of a command to the handheld printer 110. Typically, these commands would come from the user by way of pressing a button associated with triggering the printhead to begin printing. In alternate embodiments, printing is initiated via other processes that are known in the art, including, without limitation, motion sensors, position detectors, voice commands, and optics. Once the command is initiated, the user moves the handheld printer 110 to commence printing.

An LED indicator 120 serves as an alert mechanism in an embodiment. Each image file has a pointer or other end-of-image indicia to indicate to the printer that the end of the image has been reached. This end-of-image indicia serves as a signal to the controller (not shown) in the handheld printer 110 to indicate that the data in the image file has been exhausted. In other words, as the handheld printer 110 prints out the image file, it passes from the start of the image file through the image information until the end-of-image indicia is reached. In the current example, once the end-of-image indicator is reached, the LED indicator 120 is illuminated to alert the user that printing of the current image has finished.

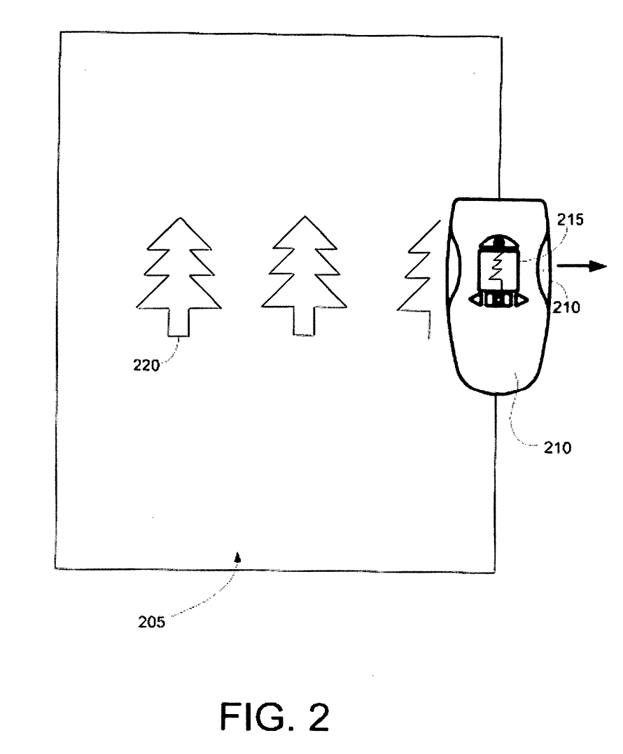

FIG. 2 is a perspective view of another embodiment of the present invention where a handheld printer 210 is shown repeatedly printing a single image. The user moves handheld printer 210 laterally across a printing surface 205 to transfer an image to the printing surface.

The image 220 may be stored in the memory of the handheld printer 210. In this particular example, the image 220 has been printed completely twice onto the printing surface 205. The user has partially printed a third reproduction of the desired image 220. In this case the printing was effectuated by the user pressing a button 210 integrated on the handheld printer 210. While the user continues to press the button 210 and move the handheld printer 210 across the printing surface 205 the printing of consecutive images will continue.

In this example, the handheld printer 210 is equipped with an LCD screen 215. The LCD screen 215 displays a representation of the amount of the currently printing image that has been printed at any given point in time. Because the user views the image 220 in the LCD screen 215 as it is printed, he or she knows when the image 220 has been completely printed.

In alternative embodiments, the end-of-image alert can take the form of an audio signal that indicates to the user when the image has been completed. Such a signal may indicate both the beginning and end of an image and may be a continuous alert or a discrete stop and start signal. One of ordinary skill will readily recognize that a variety of alerts can be used with the present invention and that a combination of alerts, such as an audio and visual alert system can be implemented. In still alternative embodiments, the handheld printer may be capable of different alert systems and may provide the user with the ability to pick between various alerts or to customize an alert via a user interface.

To ensure that the handheld printer 210 is operated at an appropriate distance from the printing surface 205 so that optimum results can be achieved, the handheld printer 210 may optionally contain spacers around the printhead, which keep the printhead at a suitable printing distance from the printing surface to provide for proper operation.

It will also be appreciated that other methods exist for the printer to recognize that an end-of-image condition has been reached. As described above, a controller or printer engine can monitor image data stored in memory. In alternative embodiments, the printer may monitor the printhead status and recognize a condition that occurs when no ink is being dispensed for a predetermined distance to determine whether the complete image 210 has been printed.

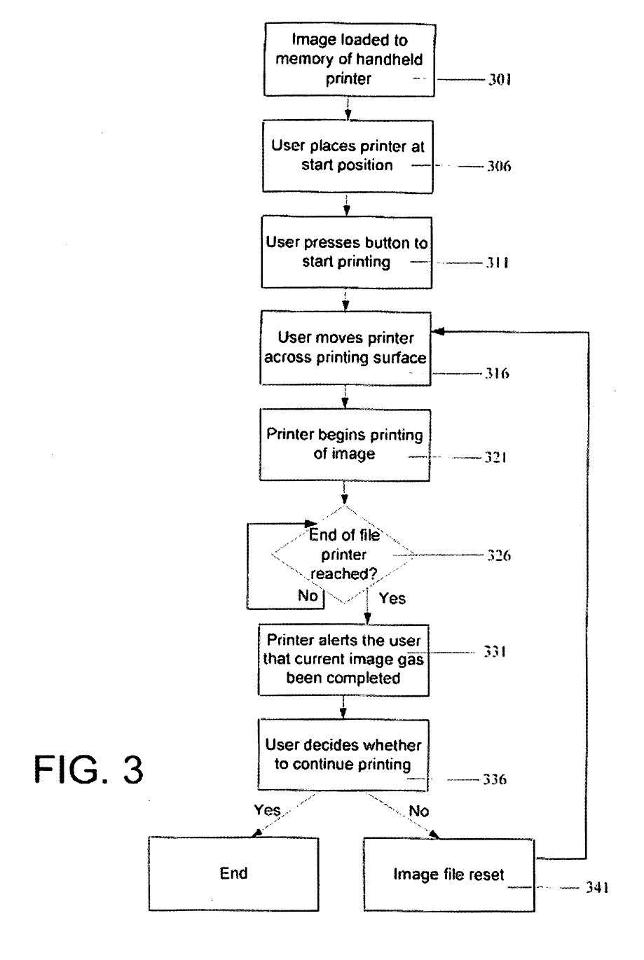

FIG. 3 is a block diagram flow chart of an end of image detection and alert method, according to an illustrative embodiment of the present invention. At step 301, one or more images are loaded in a memory of a handheld printer. The method proceeds to step 306 where the user places the printhead at the point at which the user desires to begin printing a first image.

At step 311, the user initiates the printing process, either by pressing a button or via other methods that are known in the art, some of which are described herein. At step 316, the user manually moves the printer across a media in the direction which the image is desired to be printed. While it is most common for a user to manually move the handheld printer from left to right to effectuate printing, the present invention is not limited to any particular directional movement by the user. Further the handheld printer can print regardless of whether the printer is moved in a linear direction.

As the user moves the handheld printer across the printing surface, the method moves to step 321, wherein the printer begins printing an image. The printed image can be image stored in a memory storage device that is resident in the handheld printer or the image can be stored in any data storage device that is accessible by the print engine. The process for printing an image and the types of files used to store graphic images are known in the art and outside the scope of this invention.

In one embodiment, the handheld printer is programmed to repeatedly print a single image. One of ordinary skill in the art will readily recognize that the handheld printer that is the subject of this invention can alternatively be programmed to print a single image one time, a series of images, or a repeated series of images. For purposes of illustration, the following description assumes that a single image will be repeatedly printed. In such case, the handheld printer can be programmed so the same image is repeatedly printed with a predetermined amount of space in between each image, and the process of printing consecutive copies of a single image can continue until the user terminates the printing process (e.g., by pressing a button or releasing a depressed button).

In step 326, the handheld printer determines of whether the currently printed image has been fully printed. As described above, there are many ways to indicate an end-of-image marker in the image data stored in memory. In one embodiment, the handheld device recognizes that it has reached the end of the currently printed image when it receives an end-of-image marker or pointer in the image data. If an end-of-image condition is found to occur, the process continues to step 331. If no end-of-image condition is reached, the handheld device prints that portion of the image that corresponds to the image data it receives, and the handheld printer retrieves additional image data from the memory. This process continue until and end-of-image condition is reached or until the printing operation is stopped.

In step 331, the handheld printing device notifies the user that an end-of-image marker has been reached. As discussed above, there are a number of different ways in which the alert may be communicated to the user including audio and visual indicators. Once the user is alerted that the image has been completed, the method proceeds to step 336, where the user makes a decision based on the alert as to whether they choose to continue printing or terminate printing.

If the user chooses to continue printing, the method proceeds to step 341, where the printer resets the image file and the method returns to step 316 where the printing of a second image begins.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of generating an alert using a portable printer, said alert indicating that an image has completed printing, said method comprising:
storing data representative of said image on a memory, said memory being accessible by said portable printer, said stored data including an end-of-image indicia;
transferring at least a portion of said data from said memory to a controller of said portable printer, said controller configured to cause said portable printer to print an image that corresponds to said data;
printing said image on a media in response to printing instructions received from said controller as said portable printer moves across said media, said printing instructions corresponding to said data received at said controller;
receiving at said controller said end-of-image indicia; and
generating said alert.

2. The method of claim 1, wherein said alert is an audio alert.

3. The method of claim 1, wherein said alert is a visual alert.

4. The method of claim 1, wherein said alert is an audiovisual alert.

5. The method of claim 1, wherein said portable printer is a handheld printer and said printer is manually moved across said media.

6. The method of claim 5, wherein said printing of said image on said media is performed in response to a user initiated print command.

7. The method of claim 5, wherein said portable printer is equipped with an indicator that is illuminated when said end-of-image indicia is received at said controller.

8. The method of claim 5, wherein said portable printer includes a display and said method further comprises the step of displaying a symbology that corresponds to that portion of said image that has been printed.

9. The method of claim 5, wherein said memory is integrated with said portable printer.

10. The method of claim 5, wherein said portable printer includes a media reader and said memory comprises an external storage device that is insertable into said media reader.

11. The method of claim 5, wherein said memory is external to said portable printer.

12. A portable printing device that generates an alert when an image has finished printing, comprising:
a memory that stores data corresponding to said image, said data including an end-of-image indicator;
a controller that receives said data from said memory, sends print instructions that determines when ink is ejected, and generates an alert in response to said end-of-image indicator;
a printhead that receives said print instructions from said controller and ejects ink via a plurality of nozzles; and
means for alerting a user that said end-of-image indicator has been received and said image has finished printing.

13. The portable device of claim 12, further comprising a display capable of displaying a status of the image being printed.

14. A portable printing device, comprising:
a memory for storing data that corresponds to a to-be-printed image;
a controller that receives said image data and generates print instructions;
a printhead that causes ink to be ejected on a media in accordance with said print instructions;
means for determining when said image has finished printing; and
means for generating an alert to indicate that said image has finished printing.

15. The portable device of claim 14, further comprising a display for indicating a progress status of said to-be-printed image.
